(19) United States
(12) Patent Application Publication
(10) Pub. No.: US 2012/0113949 A1
(43) Pub. Date: May 10, 2012

(54) METHOD FOR EFFICIENTLY ALLOCATING A RESOURCE IN VOIP COMMUNICATION

(76) Inventors: Jeong Ki Kim, Gyeonggi-do (KR); Ki Seon Ryu, Gyeonggi-do (KR); Young Soo Yuk, Gyeonggi-do (KR)

(21) Appl. No.: 13/384,176

(22) PCT Filed: Jul. 14, 2010
(86) PCT No.: PCT/KR2010/004580

§ 371 Date: Jan. 13, 2012

Related U.S. Application Data
(60) Provisional application No. 61/225,210, filed on Jul. 14, 2009.

(30) Foreign Application Priority Data
Jul. 14, 2010 (KR) 10-2010-0067813

(51) Int. Cl. H04W 72/08

(52) U.S. Cl. 370/329

(57) ABSTRACT

The present invention relates to a VoIP communication technique, and more particularly, to a method for performing efficient scheduling for VoIP communication and performing VoIP communication according to the schedule. According to one aspect of the present invention, a method for allocating a resource to the mobile station comprises a step of receiving a first CQICH codeword type from the mobile station; a step of allocating an uplink resource having a preset bandwidth size type for VoIP packet transmission to the mobile station for every first interval type for the VoIP packet transmission; a step of receiving a second CQICH codeword type from the mobile station; and a step of allocating an uplink resource having a preset bandwidth size type for SID packet transmission to the mobile station.

### TECHNICAL FIELD

The present invention relates to a VoIP communication technique, and more particularly, to a method for performing efficient scheduling for VoIP communication and performing VoIP communication in accordance with the scheduling.

### BACKGROUND ART

Hereinafter, a signal transmission technique for preventing resource waste and error operation of a base station from occurring in a broadband wireless access system will be described. Particularly, a method for allowing a user equipment, which uses an IP based Voice over Internet Protocol (VoIP) service, to prevent resource waste and error operation of a base station from occurring for a silence period by using a CQICH codeword will be described. To this end, VoIP traffic will first be described in brief.

VoIP traffic is characterized in that VoIP traffic having a fixed size and a fixed period is generated through VoIP codec. VoIP communication may be divided into a communication period (talk-spurt) during which communication is being performed between users and a silence period during which users are listening without speaking. This silence period occupies 50 percent or more of a general call session.

Accordingly, various voice codecs are used to allocate different bandwidths to the talk spurt and the silence period. Representative examples of the codecs may include an Adaptive Multi-Rate (AMR) scheme, G.723 and G.729, which are used in a Global System for Mobile Communication (GSM) and a Universal Mobile Telecommunications System (UMTS).

If a bandwidth is allocated to the silence period, resources will be wasted because no voice data is generated in the silence period. To prevent this, VoIP supports a silence suppression scheme. According to the silence suppression scheme, a vocoder that generates VoIP traffic does not generate traffic during the silence period and instead generates comfort noise at regular intervals in order to inform the counterpart user that a corresponding call will be maintained. For example, the vocoder that uses the AMR codec generates a fixed-size packet every 20 ms for the talk-spurt and generates comfort noise (noise packet) every 160 ms for the silence period. In this case, the comfort noise may have a format of a Silence InDicator (SID) frame.

On the other hand, a broadband wireless access system (for example, IEEE 802.16e) provides a new scheduling method, which is referred to as an Extended real-time Polling Service (‘Extended rtPS’ or ‘ErtPS’), for VoIP traffic that supports silence suppression. According to this method, a base station allocates an uplink (UL) bandwidth used for bandwidth request or data transmission to a user equipment at regular intervals and does not change the size of the UL allocation until it receives a bandwidth change request from the user equipment. When the user equipment has issued a bandwidth change request, the base station allocates only a bandwidth (unicast bandwidth request (BR) opportunity) required to transmit a bandwidth request (BR) header or does not allocate any bandwidth if the bandwidth request size has been set to zero (0). Also, if there are data, which will be transmitted to the base station, in the user equipment, the user equipment may notify the base station of it by transmitting a CQICH codeword to the base station.

### DISCLOSURE

### Technical Problem

Efficiency of a bandwidth may be achieved in accordance with the aforementioned extended real-time polling service scheme. If the user equipment performs a resource request by using the CQICH codeword, the base station allocates an uplink resource to the user equipment in accordance with a current maximum sustained traffic rate value. However, the present invention has been devised to obviate one or more problems due to limitations and disadvantages of the related art, and an object of the present invention is to provide a method for defining two types of CQICH codewords and limiting an uplink bandwidth to a silence indicator (SID) packet transmission region, which includes a general MAC header (GMH) or compact header (CH), for a silence period by using the CQICH codewords to more efficiently use a resource. Another object of the present invention is to provide a method for allowing a base station to easily identify whether a received CQICH codeword is for SID packet of a user equipment or VoIP packet by using two types of CQICH codewords.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### Technical Solutions

To achieve these objects and other advantages and in accordance with the purpose of the invention, as embodied and broadly described herein, in one aspect of the present invention, a method for allowing a base station that performs VoIP communication with a user equipment to allocate a resource to the user equipment comprises the steps of receiving a first type CQICH codeword from the user equipment; allocating an uplink resource having a first type bandwidth size to the user equipment for every first type interval; receiving a second type CQICH codeword from the user equipment; and allocating an uplink resource having a second type bandwidth size to the user equipment. In this case, it is preferable that the first type bandwidth size is preset to a bandwidth size for VoIP packet transmission, the first type interval is preset to an interval for the VoIP packet transmission, and the second type bandwidth size is preset to a bandwidth size for SID packet transmission.

In another aspect of the present invention, a method for allowing a user equipment to perform VoIP communication with a base station comprises the steps of transmitting a first type CQICH codeword to the base station; transmitting VoIP packet by using an uplink resource having a first type bandwidth size, which is allocated from the base station for every first type interval; transmitting a second type CQICH codeword to the base station; and transmitting SID packet by being allocated with an uplink resource having a second type bandwidth size from the base station. In this case, it is preferable that the first type bandwidth size is preset to a bandwidth size for VoIP packet transmission, the first type interval is preset to an interval for the VoIP packet transmission, and the second type bandwidth size is preset to a bandwidth size for SID packet transmission.

In other aspect of the present invention, a user equipment performing VoIP communication with a base station comprises a processor; and a radio frequency (RF) module for transmitting and receiving radio signals to and from the base station under the control of the processor, wherein the processor transmits a first type CQICH codeword to the base station, transmits VoIP packet to the base station by using an uplink resource having a first type bandwidth size if the uplink resource is allocated from the base station for every first type interval, transmits a second type CQICH codeword to the base station and transmits SID packet to the base station if an uplink resource having a second type bandwidth size is allocated from the base station. In this case, it is preferable that the first type bandwidth size is preset to a bandwidth size for VoIP packet transmission, the first type interval is preset to an interval for the VoIP packet transmission, and the second type bandwidth size is preset to a bandwidth size for SID packet transmission.

In the aforementioned embodiments, a scheduling service scheme applied to the VoIP communication is preferably an adaptation grant and polling (aGP) scheme.

Also, the second type CQICH codeword may be an indication flag codeword when a preset condition is satisfied. The indication flag may be used by the base station to request the user equipment of a resource for transmitting a bandwidth request header or feedback header without ranging when the preset condition is not satisfied.

Also, the preset condition may be satisfied when the base station and the user equipment decide to use the indication flag as the second type CQICH codeword through a dynamic service addition (DSA) procedure.

Further, the preset condition may be satisfied when at least one service flow of the aGP scheme exists for the user equipment.

### Advantageous Effects

According to the embodiments of the present invention, two types of CQICH codewords are defined, and an uplink bandwidth is limited to an SID packet transmission region, which includes a general MAC header (GMH) or compact header (CH), for a silence period by using the CQICH codewords, whereby a resource may be used more efficiently.

In addition, the base station may easily identify whether the received CQICH codewords are SID packet of the user equipment or VoIP packet, by using the two types of CQICH codewords.

It will be appreciated by persons skilled in the art that that the effects that could be achieved with the present invention are not limited to what has been particularly described hereinabove and other advantages of the present invention will be more clearly understood from the following detailed description.

### BRIEF DESCRIPTION OF THE DRAWINGS

FIG. 1 is a diagram illustrating a resource allocation procedure of a user equipment in VoIP communication by using one codeword in a general aGPS scheme;

FIG. 2 is a diagram illustrating a resource allocation scheme using two different codewords according to one embodiment of the present invention;

FIG. 3 is a diagram illustrating a resource allocation scheme of a base station by using an indication flag according to another embodiment of the present invention; and

FIG. 4 is a block diagram illustrating an example of a transmitter and a receiver according to other embodiment of the present invention.

### BEST MODE FOR CARRYING OUT THE INVENTION

The following embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment.

In this specification, the embodiments of the present invention have been described based on data transmission and reception between a base station and a user equipment. In this case, the base station means a terminal node of a network, which performs direct communication with the user equipment. A specific operation which has been described as being performed by the base station may be performed by an upper node of the base station as the case may be.

In other words, it will be apparent that various operations performed for communication with the user equipment in the network which includes a plurality of network nodes along with the base station may be performed by the base station or network nodes other than the base station. At this time, the base station (BS) may be replaced with terms such as a fixed station, Node B, eNode B (eNB), an access point (AP) and advanced base station (ABS). Also, the terminal may be replaced with terms such as a user equipment (UE), a mobile station (MS), a mobile subscriber station (MSS), an advanced mobile station (AMS), or a subscriber station (SS).

Also, a transmitting side means a node that provides data or voice services while a receiving side means a node that receives data or voice services. Accordingly, in an uplink, the user equipment could be the transmitting side while the base station could be the receiving side. Likewise, in a downlink, the user equipment could be the receiving side while the base station could be the transmitting side.

In the mean time, in the present invention, examples of the user equipment may include a personal digital assistant (PDA), a cellular phone, a personal communication service (PCS) phone, a global system for mobile (GSM) phone, a wideband CDMA (WCDMA) phone, and a mobile broadband system (MBS) phone. Also, the user equipment may be a personal digital assistant (PDA), a hand-held PC, a notebook PC, a smart phone, or a multi mode-multi band (MM-MB) terminal.

In this case, the smart phone is a terminal provided with advantages of a mobile communication terminal and a personal digital assistant (PDA). The smart phone may mean a terminal in which a schedule management function of the PDA and data communication functions of facsimile transmission/reception, internet access, etc. are integrated on the mobile communication terminal. Also, the multimode-multiband terminal means a terminal having a built-in multi-MODEM chip to be operable in a portable internet system and other mobile communication systems (e.g., CDMA (code division multiple access) 2000 system, WCDMA (wideband CDMA) system, etc.).

The embodiments according to the present invention may be implemented by various means, for example, hardware, firmware, software, or their combination.

If the embodiment according to the present invention is implemented by hardware, the embodiments of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, methods according to the embodiments of the present invention may be implemented by a type of a module, a procedure, or a function, which performs functions or operations described as below. For example, a software code may be stored in a memory unit and then may be driven by a processor. The memory unit may be located inside or outside the processor to transmit and receive data to and from the processor through various means which are well known.

The embodiments of the present invention may be supported by standard documents disclosed in at least one of wireless access systems, i.e., IEEE 802 system, 3GPP system, 3GPP LTE system, and 3GPP2 system. Namely, among the embodiments of the present invention, apparent steps or parts, which are not described to clarify technical spirits of the present invention, may be supported by the above documents. Also, all terminologies disclosed herein may be described by the above standard documents. Particularly, the embodiments of the present invention may be supported by one or more of standard documents of IEEE 802.16 system, i.e., P802.16e-2004, P802.16e-2005, P802.16Rev2, and P802.16m.

Hereinafter, the preferred embodiments of the present invention will be described with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out.

Also, specific terminologies hereinafter used in the embodiments of the present invention are provided to assist understanding of the present invention, and various modifications may be made in the specific terminologies within the range that they do not depart from technical spirits of the present invention.

Hereinafter, a method for allowing a user equipment, which uses VoIP service, to prevent resource waste and error operation of a base station from occurring for a silence period by using two types of CQICH codewords will be described. To this end, an extended real-time polling service scheme will first be described in detail.

First of all, a scheduling service and an adaptive granting and polling service (aGPS) scheme that is a kind of the scheduling service will be described.

The scheduling service is a data processing mechanism supported by a medium access control (MAC) scheduler and is for data transmission on connection. Each service flow corresponds to one scheduling service. The scheduling service is determined by a set of service flow quality of service (SF QoS) parameters. These parameters may be established or modified by flow management procedures.

As described above, the aGPS scheme is a kind of a scheduling service used in the IEEE 802.16m system. A set of QoS parameters based on the aGPS scheme may be classified into primary SF QoS parameters and secondary SF QoS parameters.

The base station may grant or poll a resource to the user equipment at regular intervals, or may perform negotiation for the primary and/or secondary QoS parameters. Generally, the base station initially uses the primary QoS parameters only. In this case, the primary QoS parameters include primary Grant and Polling Interval (GPI) and primary grant size.

Of the service, traffic characteristics and QoS requirements may be modified. An example of this modification may include a case where a talk spurt and a silence period are repeated in VoIP communication to which a silence suppression scheme is applied. In this case, a scheduling service status modification mechanism based on the aGPS scheme may be triggered. Adaptation (modification) of the scheduling service status may be performed in a type of mutual switching between the primary SF QoS parameters and the secondary SF QoS parameters or modification of GPI and grant size.

Although the following description is based on VoIP communication to which the aGPS scheme is applied, it is not necessarily required that the VoIP communication should be limited to the aGPS scheme.

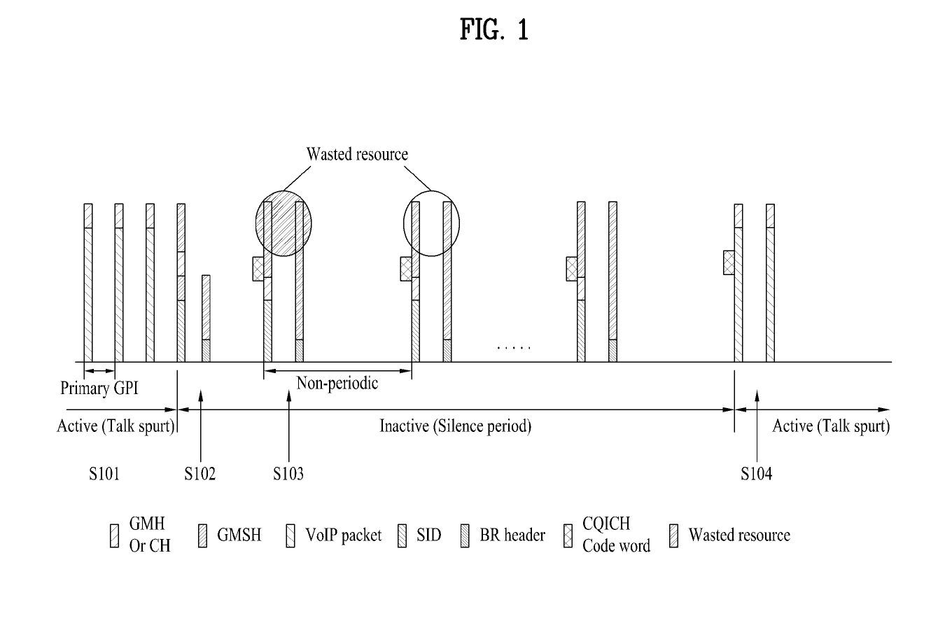

FIG. 1 is a diagram illustrating a resource allocation procedure of a user equipment in VoIP communication by using one codeword in a general aGPS scheme.

At step S101 of FIG. 1, the user equipment may transmit VoIP packet, which includes a general MAC header (GMH) or compact header (CH), to the base station for a talk spurt at regular intervals. To this end, the base station may perform uplink resource allocation to the user equipment at a period corresponding to a primary GPI, wherein the uplink resource may be used for bandwidth request and data transmission. At this time, the size of the allocated resource may basically correspond to a maximum sustained traffic rate value.

If the user equipment shifts from the talk spurt to the silence period, it generates SID instead of VoIP packet. The user equipment may request the base station to modify the size of the bandwidth allocated thereto by using an extended piggyback request field of a grant management subheader (GMSH) or a bandwidth request (BR) field of a MAC signaling header for the silence period (S102). Also, the user equipment may request the base station to modify the size of the bandwidth by transmitting CQICH codeword to the base station (S103). The base station that has received the CQICH codeword may allocate the uplink resource to the user equipment in accordance with a current maximum sustained traffic rate value. Accordingly, resource waste may occur as marked by oblique lines in FIG. 1.

Further, if one CQICH codeword is used, the base station has a difficulty in identifying whether the CQICH codeword transmitted from the user equipment is for SID packet or VoIP packet. In other words, if the user equipment again enters the talk spurt and transmits the CQICH codeword for the VoIP packet at step S104, the base station has a difficulty in identifying the CQICH codeword.

### First Embodiment

Accordingly, a method for allowing a user equipment to define two types of CQICH codewords and perform VoIP communication by using the CQICH codewords in accordance with one embodiment of the present invention will be described below. The two CQICH codewords defined in accordance with this embodiment will be referred to as a primary CQICH codeword and a secondary CQICH codeword. In this case, the codeword may mean a binary sequence corresponding to a specific index of a feedback content of a predetermined feedback channel (for example, primary fast feedback channel (PFBCH)) or a quick access message content/bandwidth request (BR) indicator.

In the mean time, QoS parameters of the aGPS scheme, which will be used in the present invention, are as follows.
Maximum sustained traffic rate is a parameter indicating a maximum information rate of a service.
Adaptation method indicates adaptive grant and polling service (aGPS) action type.
GPI_Primary is a primary grant and polling interval, and is hereinafter used as an interval for VoIP packet transmission for a talk spurt.
GPI_Secondary is a secondary grant and polling interval, and is hereinafter used as an interval for SID packet transmission for a silence period.
GrantSize_Primary is a primary grant size, and is hereinafter used to represent an uplink bandwidth size for VoIP packet transmission.
GrantSize_Secondary is a secondary grant size, and is hereinafter used to represent an uplink bandwidth size for SID packet transmission.

The aforementioned QoS parameters may be divided into primary QoS parameters (i.e., GPI_Primary and GrantSize_Primary) for VoIP packet transmission at the talk spurt and secondary QoS parameters (i.e., GPI_Secondary and GrantSize_Secondary) for SID packet transmission at the silence period. The aforementioned primary CQICH codeword and the aforementioned secondary CQICH codeword will be described using the QoS parameters.
Primary CQICH codeword (or primary bandwidth request (BR) indicator)

If there are data based on the primary QoS parameters, which will be transmitted to the base station, in the user equipment, the user equipment may transmit the data to the base station to notify the base station of it.

If the base station receives the primary CQICH codeword, it may allocate uplink burst based on the GrantSize_Primary to the user equipment. If the base station receives the corresponding CQICH codeword in a state that the current QoS parameters are not the primary QoS parameters (for example, silence period), it may modify the current QoS parameters to the primary QoS parameters.
Secondary CQICH codeword (or secondary bandwidth request (BR) indicator)

If there are data (i.e., corresponding to GrantSize_Secondary size) based on the secondary QoS parameters, which will be transmitted to the base station, in the user equipment, the user equipment may transmit the data to the base station to notify the base station of it.

If the base station receives the secondary CQICH codeword, it may allocate uplink burst based on the GrantSize_Secondary to the user equipment. If the base station receives the corresponding CQICH codeword in a state that the current QoS parameters are not the secondary QoS parameters (for example, talk spurt), it may modify the current QoS parameters to the secondary QoS parameters.

The aforementioned two CQICH codewords may be transmitted to the base station through any one type of an adaptation request bandwidth request signaling header, a service specific scheduling control header, a quick access message transmitted through a bandwidth request (BR) channel, and an aGPS bandwidth/feedback content transmitted through a primary fast feedback control channel (P-FBCH).

The aforementioned primary/secondary CQICH codewords (or BR indicator) may be transmitted to the base station through the PFBCH in the type of the feedback content as illustrated in Table 1 below.

TABLE 1

| | Related | |
|---|---|---|
| | MIMO | |
| PFBCH Feedback | feedback | |
| Content | mode | Description/Notes |
| . . . | . . . | . . . |
| Primary BR | N/A | This is used to request UL |
| Indicator (TBD) | | bandwidth. |
| | | If the scheduling service type |
| | | is aGPS, the field corresponds |
| | | to the largest |
| | | GrantSize_primary of the AMS's |
| | | aGPS UL service flows. |
| | | If the scheduling service type |
| | | is ertPS, the field corresponds |
| | | to the largest Maximum |
| | | Sustained Traffic Rate of the |
| | | MS's stopped ertPS UL service |
| | | flows |
| | | On-demand |
| Secondary BR | N/A | This is used to request UL |
| Indicator (TBD) | | bandwidth. |
| | | The field corresponds to the |
| | | largest GrantSize_secondary of |
| | | the AMS's aGPS UL service |
| | | flows. |
| | | On-demand |
| . . . | . . . | . . . |

Hereinafter, various embodiments based on the aforementioned concept will be described.

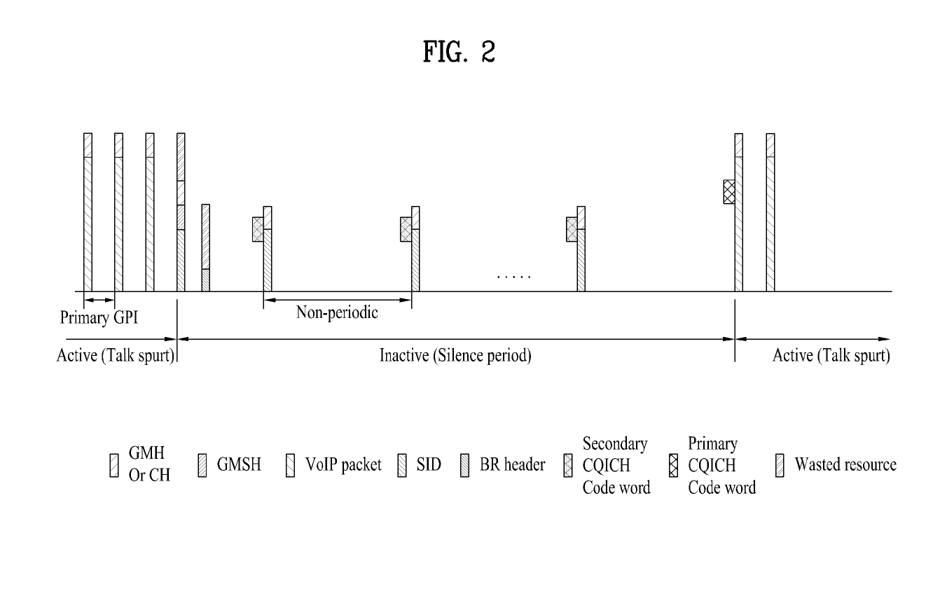

FIG. 2 is a diagram illustrating a resource allocation scheme using two different codewords according to one embodiment of the present invention.

In FIG. 2, it is assumed that GPI primary is set to 20 ms, and GrantSize_Primary and GrantSize_Secondary are set to VoIP packet and SID packet, respectively. It is also assumed that GPI_Secondary is not defined in the embodiment of FIG. 2.

If the GPI_secondary value is not defined and an adaptation method is an allocation scheme of one time, it is suggested that the base station that has received the secondary CQICH codeword allocates an uplink resource based on the GrantSize_secondary one time. In other words, as shown in FIG. 2, the user equipment transmits the secondary CQICH codeword every time to transmit the SID packet, and the base station that has received it allocates an uplink resource for each secondary CQICH codeword once.

In this embodiment, if the base station receives the primary CQICH codeword (that is, if the user equipment that has entered the talk spurt transmits the primary CQICH codeword), the base station may allocate the bandwidth (uplink resource) of GrantSize_primary size at an interval of GPI_Primary by modifying the current QoS parameters to the primary QoS parameters.

### Second Embodiment

The user equipment may transmit an indication flag through the aforementioned PFBCH. The indication flag is a kind of a codeword, and may be transmitted to the base station to notify that the user equipment transmits a feedback header or BR header to the base station without ranging. If the base station receives the indication flag from the user equipment, it allocates an uplink resource to the user equipment, wherein the uplink resource is required for the user equipment to transmit a header. In order to maintain the operation of the link adaptation mechanism, it is preferable that the indication flag is not transmitted continuously twice or more when it is transmitted through the PFBCH.

The other embodiment of the present invention suggests that the aforementioned indication flag is used for modification to the secondary QoS parameters. In other words, the other embodiment of the present invention suggests that the indication flag is used to perform the same function as the secondary CQICH codeword (or secondary bandwidth request (BR) indicator) described in one embodiment of the present invention under predetermined conditions.

Preferably, the predetermined conditions are 1) the case where one or more aGPS services exist in the user equipment, or 2) the case where it is negotiated to use the indication flag as the secondary CQICH codeword at a service setup step.

In a state that the aforementioned conditions are satisfied, if the base station receives the indication flag through the PFBCH, it may allocate uplink burst based on the secondary QoS parameters to the user equipment. If a plurality of aGPS services for the corresponding user equipment are provided, the resource corresponding to the largest one, that is, GrantSize_Secondary, of all the services may be allocated to the user equipment. Also, in a state that the current QoS parameters are not the secondary QoS parameters (for example, talk spurt), if the base station receives the indication flag, it may modify the current QoS parameters to the secondary QoS parameters.

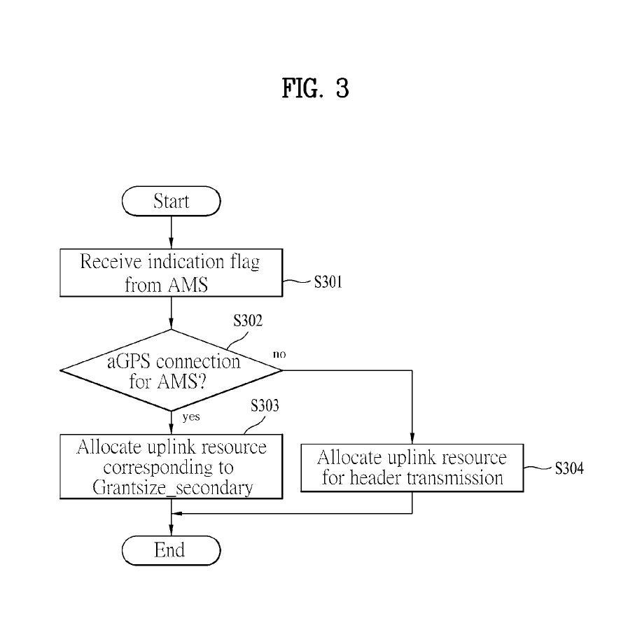

Hereinafter, a bandwidth allocation procedure based on the condition 1) will be described with reference to FIG. 3.

FIG. 3 is a diagram illustrating a resource allocation scheme of a base station by using an indication flag according to another embodiment of the present invention.

Referring to FIG. 3, first of all, the base station may receive the indication flag through the PFBCH (S301).

At this time, the base station may determine whether aGPS service exists for the user equipment that has transmitted the indication flag (S302).

If the aGPS service exists for the user equipment, the base station may allocate the uplink burst based on the secondary QoS parameters to the user equipment (S303).

By contrast, if the aGPS service does not exist for the user equipment, the base station may allocate a resource for allowing the user equipment to transmit a bandwidth request header or feedback header, to the user equipment in accordance with a purpose of use of the indication flag (S304).

Hereinafter, a type of a dynamic service addition (DSA) message for modification of a purpose of use of the indication flag at the service setup step in accordance with the condition 2) will be described with reference to Table 2.

Table 2 illustrates a part of aGPS QoS parameters that may be included in dynamic service addition message (AAI_DSA-REQ/RSP) messages according to another embodiment of the present invention.

TABLE 2

| Information Element | Notes |
|---|---|
| Maximum Latency | . . . |
| (unsigned int) | |
| Tolerated Jitter | |
| (unsigned int) | |
| Minimum Sustained | |
| Traffic Rate | |
| (unsigned int) | |
| Maximum Sustained | . . . |
| Traffic Rate | |
| (unsigned int) | |
| Traffic Priority | |
| (unsigned int) | |
| Request/Transmission | |
| Policy (unsigned int) | |
| If (uplink service | |
| flow) { | |
| (Boolean) | |
| Scheduling Type | aGPS |
| (unsigned int) | |
| GPI_Primary | Primary GPI, used initially |
| (unsigned int) | |
| GrantSize_primary | Primary grant size, if the primary |
| (unsigned int) | grant size equals to x bytes (the |
| | newly defined bandwidth request header |
| | size), this indicates a primarily |
| | polling based service; otherwise, it |
| | is primarily granting based service. |
| GPI_Secondary | Secondary GPI (optional) |
| (unsigned int) | |
| GrantSize_Secondary | Secondary grant size (optional). If |
| (unsigned int) | the secondary grant size is defined |
| | and equals to x bytes (the newly |
| | defined bandwidth request header |
| | size), this indicates a secondarily |
| | polling based service; otherwise, it |
| | is secondarily granting based service. |
| aGPS Secondary BR | If this flag is set to 1, an |
| indicator flag | indication flag feedback shall be used |
| | for the AMS to inform the serving ABS |
| | of the existence of pending aGPS data |
| | related to secondary QoS parameters |
| Adaptation Method | ABS-initiated adaptation |
| (unsigned int) | AMS-initiated adaptation |
| } | |

Referring to Table 2, aGPS secondary BR indication flag may be included in the aGPS service setup related parameter of the DSA message to indicate whether the indication flage is used as a codeword corresponding to the secondary CQICH codeword (or secondary BR indicator).

Accordingly, if the purpose of use modification of the indication flag according to this embodiment is performed, since the CQICH codeword for the secondary QoS parameters may not be allocated separately, it may be saved.

Configuration of User Equipment and Base Station

Hereinafter, a user equipment and a base station ABS (femto BS (FBS) and macro BS (MBS)) for implementing the aforementioned embodiments of the present invention will be described in accordance with still another embodiment of the present invention.

The user equipment may be operated as a transmitter on an uplink and as a receiver on a downlink. Also, the base station ABS may be operated as a receiver on the uplink and as a transmitter on the downlink. In other words, each of the user equipment and the base station may include a transmitter and a receiver for transmission of information or data.

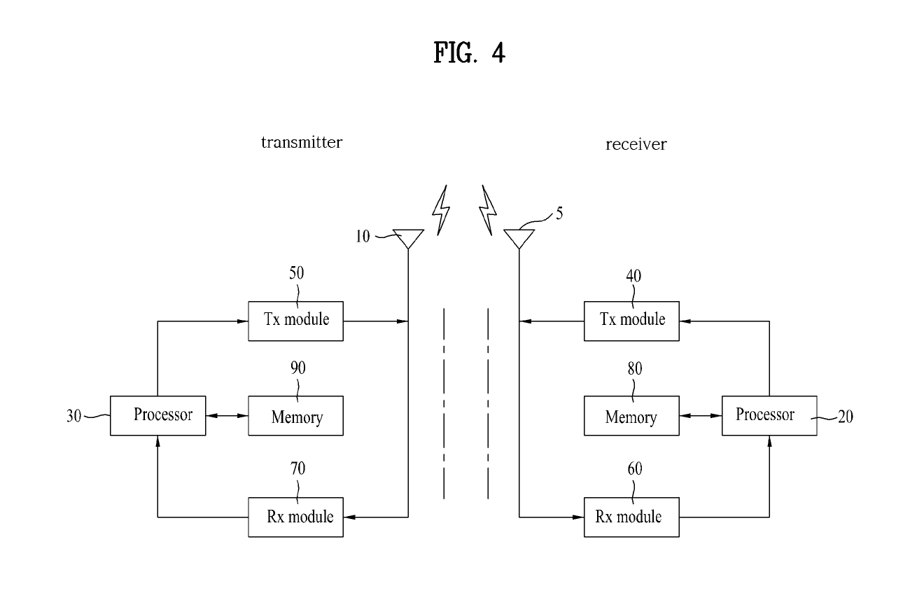

The transmitter and the receiver may include a processor, modules, parts, and/or means for implementing the embodiments of the present invention. Especially, the transmitter and the receiver may include a module (means) for encrypting messages, a module for interpreting encrypted messages, an antenna for transmitting and receiving messages, etc. An example of the transmitter and the receiver will be described below with reference to FIG. 4.

FIG. 4 is a block diagram illustrating an example of a transmitter and a receiver according to still another embodiment of the present invention.

Referring to FIG. 4, the left part corresponds to the transmitter and the right part corresponds to the receiver. Each of the transmitter and the receiver may include an antenna 5 or 10, a processor 20 or 30, a Transmission (Tx) module 40 or 50, a Reception (Rx) module 60 or 70, and a memory 80 or 90. The components of the transmitter are complementary to those of the receiver. The components of the transmitter and the receiver will be described below in more detail.

The antenna 5 or 10 serves to transmit signals generated from the Tx module 40 or 50 or externally receive radio frequency (RF) signals and transfer the received RF signals to the Rx module 60 or 70. If a Multiple Input Multiple Output (MIMO) function is supported, two or more antennas may be provided.

The antenna, the Tx module, and the Rx module may together constitute an RF module.

The processor 20 or 30 generally controls the overall operation of the user equipment. For example, the processor 20 or 30 may perform a controller function for implementing the aforementioned embodiments of the present invention, a variable Medium Access Control (MAC) frame control function based on service characteristics and a propagation environment, a handover (HO) function, an authentication and encryption function, etc.

In particular, the processor of the base station may perform a control function for performing the embodiments of the present invention in the aforementioned VoIP communication. For example, the processor of the base station may control scheduling using two sets of QoS parameters (GPI_Primary, GPI_Secondary, GrantSize_Primary and GrantSize_Secondary) depending on which one of two CQICH codewords is received from the user equipment. The processor of the user equipment may control VoIP packet transmission and SID packet transmission based on the scheduling. The processor 20 or 30 may have a layered structure such as MAC and PHY.

In addition, the processor of the user equipment may perform the overall control for the operations described in the aforementioned embodiments.

The Tx module 40 or 50 may perform predetermined coding and modulation for data, which are scheduled from the processor 20 or 30 and will be transmitted to the outside, and then may transfer the coded and modulated data to the antenna 10.

The Rx module 60 or 70 may recover original data by decoding and demodulating data received through the antenna 5 or 10 and provide the recovered data to the processor 20 or 30.

The memory 80 or 90 may store programs for processing and control of the processor 20 or 30 and temporarily store input/output (I/O) data. Also, the memory 80 or 90 may include at least one type of storage media such as a flash memory, a hard disk, a multimedia card micro, a card-type memory (e.g. a Secure Digital (SD) or eXtreme Digital (XD) memory), a Random Access Memory (RAM), a Static Random Access Memory (SRAM), a Read-Only Memory (ROM), an Electrically Erasable Programmable Read-Only Memory (EEPROM), a Programmable Read-Only Memory (PROM), a magnetic memory, a magnetic disc, an optical disc, etc.

In the mean time, the base station may perform a control function for implementing the aforementioned embodiments of the present invention, Orthogonal Frequency Division Multiple Access (OFDMA) packet scheduling, Time Division Duplex (TDD) packet scheduling and channelization, a variable MAC frame control function based on service characteristics and a propagation environment, a real-time high-speed traffic control function, a handover function, an authentication and encryption function, a packet modulation/demodulation function for data transmission and reception, a high-speed packet channel coding function, a real-time MODEM control function, etc., through at least one of the aforementioned modules, or the base station may further include an additional means, module, or part for performing these functions.

Those skilled in the art will appreciate that the present invention may be carried out in other specific ways than those set forth herein without departing from the spirit and essential characteristics of the present invention. It is also obvious to those skilled in the art that claims that are not explicitly cited in each other in the appended claims may be presented in combination as an embodiment of the present invention or included as a new claim by a subsequent amendment after the application is filed.

### INDUSTRIAL APPLICABILITY

Although the aforementioned method for transmitting VoIP data in a broadband wireless access system and the user equipment for the same have been described based on the IEEE 802.16m system, it may be applied to various mobile communication systems having a femto base station in addition to the IEEE 802.xx system.

1. A method for allowing a base station that performs VoIP communication with a user equipment to allocate a resource to the user equipment, the method comprising the steps of:
receiving a first type CQICH codeword from the user equipment;
allocating an uplink resource having a first type bandwidth size to the user equipment for every first type interval;
receiving a second type CQICH codeword from the user equipment; and
allocating an uplink resource having a second type bandwidth size to the user equipment,
wherein the first type bandwidth size is preset to a bandwidth size for VoIP packet transmission, the first type interval is preset to an interval for the VoIP packet transmission, and the second type bandwidth size is preset to a bandwidth size for SID packet transmission.

2. The method according to claim 1, wherein a scheduling service scheme applied to the VoIP communication is an adaptation grant and polling (aGP) scheme.

3. The method according to claim 2, wherein the second type CQICH codeword is an indication flag codeword transmitted from the user equipment when a preset condition is satisfied.

4. The method according to claim 3, wherein the preset condition is characterized in that the base station and the user equipment decide to use the indication flag as the second type CQICH codeword through a dynamic service addition (DSA) procedure.

5. The method according to claim 3, wherein the preset condition is characterized in that at least one service flow of the aGP scheme exists for the user equipment.

6. A method for allowing a user equipment to perform VoIP communication with a base station, the method comprising the steps of:
transmitting a first type CQICH codeword to the base station;
transmitting VoIP packet by using an uplink resource having a first type bandwidth size, which is allocated from the base station for every first type interval;
transmitting a second type CQICH codeword to the base station; and
transmitting SID packet by being allocated with an uplink resource having a second type bandwidth size from the base station,
wherein the first type bandwidth size is preset to a bandwidth size for VoIP packet transmission, the first type interval is preset to an interval for the VoIP packet transmission, and the second type bandwidth size is preset to a bandwidth size for SID packet transmission.

7. The method according to claim 6, wherein a scheduling service scheme applied to the VoIP communication is an adaptation grant and polling (aGP) scheme.

8. The method according to claim 7, wherein the second type CQICH codeword is an indication flag codeword transmitted from the user equipment when a preset condition is satisfied.

9. The method according to claim 8, wherein the preset condition is characterized in that the base station and the user equipment decide to use the indication flag as the second type CQICH codeword through a dynamic service addition (DSA) procedure.

10. The method according to claim 8, wherein the preset condition is characterized in that at least one service flow of the aGP scheme exists for the user equipment.

11. A user equipment performing VoIP communication with a base station, the user equipment comprising:
a processor; and
a radio frequency (RF) module for transmitting and receiving radio signals to and from the base station under the control of the processor,
wherein the processor transmits a first type CQICH codeword to the base station, transmits VoIP packet to the base station by using an uplink resource having a first type bandwidth size if the uplink resource is allocated from the base station for every first type interval, transmits a second type CQICH codeword to the base station and transmits SID packet to the base station if an uplink resource having a second type bandwidth size is allocated from the base station, and the first type bandwidth size is preset to a bandwidth size for VoIP packet transmission, the first type interval is preset to an interval for the VoIP packet transmission, and the second type bandwidth size is preset to a bandwidth size for SID packet transmission.

12. The user equipment according to claim 11, wherein a scheduling service scheme applied to the VoIP communication is an adaptation grant and polling (aGP) scheme.

13. The user equipment according to claim 12, wherein the processor transmits an indication flag codeword transmitted to the base station as the second type CQICH codeword when a preset condition is satisfied.

14. The user equipment according to claim 13, wherein the preset condition is characterized in that the base station and the user equipment decide to use the indication flag as the second type CQICH codeword through a dynamic service addition (DSA) procedure.

15. The user equipment according to claim 13, wherein the preset condition is characterized in that at least one service flow of the aGP scheme exists for the user equipment.
